(19) United States
(12) Patent Application Publication
(10) Pub. No.: US 2026/0015838 A1
(43) Pub. Date: Jan. 15, 2026

(54) SHOWER COLUMN

(71) Applicant: XIAMEN PRIME SHOWER CO., LTD., XIAMEN (CN)

(72) Inventors: JING GUO, XIAMEN (CN); YONGLIANG DENG, XIAMEN (CN); HAIBO HONG, XIAMEN (CN); QIN YU, XIAMEN (CN)

(73) Assignee: XIAMEN PRIME SHOWER CO., LTD., XIAMEN (CN)

(21) Appl. No.: 18/810,597

(22) Filed: Aug. 21, 2024

(30) Foreign Application Priority Data
Jul. 10, 2024 (CN) 202421629000.3

(51) Int. Cl. E03C 1/04; B05B 15/62; E03C 1/02

(52) U.S. Cl. CPC E03C 1/0408; B05B 15/62; E03C 2001/026

(57) ABSTRACT

The present disclosure provides a shower column, including: a lifting rod; a first connection seat arranged on an upper end of the lifting rod and internally provided with two independent water passages; a switching valve arranged on a lower end of the lifting rod and configured to switch a connection relationship among passages inside the lifting rod; a top spray and a water inlet elbow respectively matching with the first connection seat, wherein the water inlet elbow is rotatably connected to the water passage; a telescopic assembly arranged on a side of the switching valve and configured to adjust a distance between the switching valve and a wall body; and a shower assembly connected to a first valve outlet, a lifter is configured to place a handheld shower.

### TECHNICAL FIELD

The present disclosure pertains to the technical field of shower devices, in particular to a shower column.

### BACKGROUND

The Chinese utility model patent application No. CN200920138126.X discloses a shower column assembly which comprises a shower column connected to a water supply pipe, a shower head connected to an outlet end of the shower column, and a fixing seat for fixing the shower column; wherein the shower head is provided with at least two functional water divisions; and the shower column is provided with at least two water passages respectively connected to the functional water divisions of the shower head; in addition, the shower column is provided with a water passage switching device, and the water passage switching device is provided with a water inlet connected to the water supply pipe and at least two water outlets, the two water outlets are respectively connected to the two water passages of the shower column, and the connection between the two water outlets and the water inlet is controlled and switched by the water passage switching device to realize different water outlet settings of the shower head. The shower column assembly features easy operation for users and convenient use, thereby meeting people's different demands when taking a shower.

However, the entire shower column is fixed by fixing the shower column assembly on the fixing seat, its installation is complicated, and the shower column is fixedly connected to the fixing seat and cannot be flexibly adjusted, causing poor adaptability.

### SUMMARY

The present disclosure provides a shower column, aiming to solve the problem that the existing shower column assembly is complicated to install and the column body cannot be flexibly adjusted.

In order to solve the above technical problems, the present disclosure provides the following

### Technical Solutions

A shower column, comprising:
a lifting rod;
a first connection seat, wherein the first connection seat is arranged on an upper end of the lifting rod, and the first connection seat is internally provided with two independent water passages;
a switching valve, wherein the switching valve is arranged on a lower end of the lifting rod, the switching valve comprises a valve water inlet, a first valve outlet and a second valve outlet, and the valve water inlet, the first valve outlet and the second valve outlet are in communication with each other, the switching valve is provided with a switching assembly configured to switch a connection relationship among the valve water inlet, the first valve outlet and the second valve outlet;
the two water passages provided in an interior of the first connection seat each has a first end and the first ends of the water passages are respectively connected to a top spray and a water inlet elbow, the water inlet elbow is rotatably connected to the water passage at a joint position, the two water passages each has a second end and the second ends of the water passages are respectively connected to the valve water inlet and the second valve outlet;
a telescopic assembly, wherein the telescopic assembly is arranged on a side of the switching valve, and the telescopic assembly is configured to adjust a distance between the switching valve and a wall body; and
a shower assembly, wherein the shower assembly communicates with the first valve outlet.

Furthermore, the first connection seat is provided with a first water inlet, a first water outlet, a second water inlet and a second water outlet, the first water inlet communicates with the first water outlet, and the second water inlet communicates with the second water outlet, thereby forming the two water passages. The water inlet communicates with the first water outlet, and the second valve outlet communicates with the second water inlet; the first water inlet communicates with an end of the water inlet elbow and is rotatably connected thereto, and the second water outlet communicates with the top spray. The switching assembly comprises a valve core and a switching handle, and the switching handle works with the valve core to change the connection relationship among the valve water inlet, the first valve outlet and the second valve outlet.

Furthermore, the telescopic assembly comprises a rotatable ring, a telescopic tube and a clamping ring, the telescopic tube is inserted into an inner cavity of the switching valve, the switching valve is connected to the rotatable ring by threads at an end of the switching valve matching with the telescopic tube, an inner cavity of the rotatable ring is configured with the clamping ring for cooperation, the clamping ring is sleeved on a circular outer wall of the telescopic tube, chamfers are provided at two ends of the clamping ring, and an inclined surface that fits with the chamfers is provided on an inner wall of the rotatable ring; and the rotatable ring and the clamping ring work together to clamp or release the telescopic tube.

Furthermore, the water inlet elbow communicates with the first water inlet through a first rotary head or a second rotary head.

Furthermore, the first rotary head comprises a ball head, the ball head is arranged in an inner cavity of the first water inlet, a sealing ring and a washer are arranged between the ball head and the first water inlet, and the sealing ring contacts the ball head. An end of the ball head away from the first water inlet is sleeved with a ball sleeve, the first water inlet is connected with a compression nut by threads, and the compression nut is configured to ensure close contact between the ball sleeve and the ball head. An end of the ball head away from the first water inlet is connected with a connector by threads, the connector extends out of the compression nut, a connection nut is sleeved on the connector, an interior of the connection nut is provided with a filter washer, and the connection nut is connected to an end of the water inlet elbow by threads.

Furthermore, the second rotary head comprises a water inlet ball head arranged at the first water inlet, a connection sleeve is arranged on the water inlet ball head, an interior of the connection sleeve is provided with a first spherical pad and a second spherical pad, and the first spherical pad and the second spherical pad are respectively mounted on an upper end and a lower end of the water inlet ball head.

Furthermore, the second water outlet is connected to the top spray via a cantilevered tube, the cantilevered tube is rotatably connected to the second water outlet, and a locking assembly is provided at the second water outlet for locking the cantilevered tube and the second water outlet.

Furthermore, the locking assembly comprises a connection rod, a first end of the connection rod is connected to an inner cavity of the second water outlet, a second end of the connection rod extends to an outer side of the second water outlet and is connected to a threaded rod, the connection rod and the threaded rod are arranged in coaxial with the second water outlet, an end of the cantilevered tube is sleeved on the connection rod, the threaded rod passes through the cantilevered tube, and the threaded rod is sequentially sleeved with a wear-resistant ring and a decorative cover and then connected to an adjustment handle by threads.

Furthermore, an inner cavity of the second water outlet is provided with a first toothed disk matched with the cantilevered tube, and a surface where the cantilevered tube matches with the second water outlet is provided with a second toothed disk, and the first toothed disk is adapted to the second toothed disk.

Furthermore, the shower assembly comprises a hose and a handheld shower, a first end of the hose is connected to the first valve outlet, and a second end of the hose is connected to the handheld shower, the lifting rod is provided with a lifter, and the lifter is configured to place the handheld shower.

Compared with the prior art, the present disclosure has the following technical effects.
1. According to the shower column described in the present disclosure, the upper end of the lifting rod is rotatably connected to the water inlet elbow through the first connection seat, so as to realize flexible adjustment of the posture of the lifting rod and the lifting rod doesn't need to be fixed, such that the specific placement of the lifting rod can be adjusted according to different occasions, thereby improving the adaptability and flexibility.
2. The shower column described in the present disclosure can flexibly adjust the distance between the switching valve and the wall body through the telescopic assembly arranged at the lower end of the lifting rod, thereby adjusting the distance between the lifting rod and the wall body and realizing flexible adjustment according to user's specific needs.

### BRIEF DESCRIPTION OF THE DRAWINGS

FIG. 1 is a schematic diagram showing a first arrangement of a shower column according to the present disclosure.

FIG. 2 is a schematic diagram showing the rod system of the shower column according to the present disclosure.

FIG. 3 is a schematic diagram of a first rotary head of the shower column according to the present disclosure.

FIG. 4 is a schematic diagram of a telescopic assembly of the shower column according to the present disclosure.

FIG. 5 is a schematic diagram of the telescopic assembly of the shower column according to the present disclosure after the telescopic assembly being extended.

FIG. 6 is a schematic diagram of a switching valve of the shower column according to the present disclosure.

FIG. 7 is a schematic diagram showing a second arrangement of the shower column according to the present disclosure.

FIG. 8 is a schematic diagram showing a third arrangement of the shower column according to the present disclosure.

FIG. 9 is a schematic diagram showing a top spray and a water inlet elbow of the shower column in the third arrangement according to the present disclosure.

FIG. 10 is a structural schematic diagram of a first connection seat in the third arrangement of the shower column according to the present disclosure.

FIG. 11 is a structural schematic diagram of a locking assembly in the third arrangement of the shower column according to the present disclosure.

FIG. 12 is a structural schematic diagram of a second rotary head of the shower column according to the present disclosure.

The reference numerals in the drawings are listed below: 1. lifting rod; 2. first connection seat; 201. first water inlet; 202. first water outlet; 203. second water inlet; 204. second water outlet; 205. end cover; 206. outer shell; 207. water inlet ball head; 208. connection rod; 209. threaded rod; 210. first toothed disk; 3. switching valve; 301. first valve outlet; 302. switching handle; 303. valve water inlet; 304. second valve outlet; 305. valve core; 306. second connection seat; 4. telescopic assembly; 401. rotatable ring; 402. telescopic tube; 403. clamping ring; 404. auxiliary washer; 5. first rotary head; 501. ball head; 502. sealing ring; 503. washer; 504. ball sleeve; 505. compression nut; 506. connector; 507. connection nut; 508. filter washer; 6. lifter; 7. top spray; 8. water inlet elbow; 9. second rotary head; 901. connection sleeve; 902. first spherical pad; 903. second spherical pad; 10. cantilevered tube; 1001. second toothed disk; 11. locking assembly; 1101. wear-resistant ring; 1102. decorative cover; 1103. adjustment handle.

### DETAILED DESCRIPTION OF THE EMBODIMENTS

In order to make the objectives, technical solutions and advantages of the present disclosure clearer, the technical solutions of the present disclosure will be clearly and completely described below in combination with the specific embodiments of the application and with reference to the accompanying drawings.

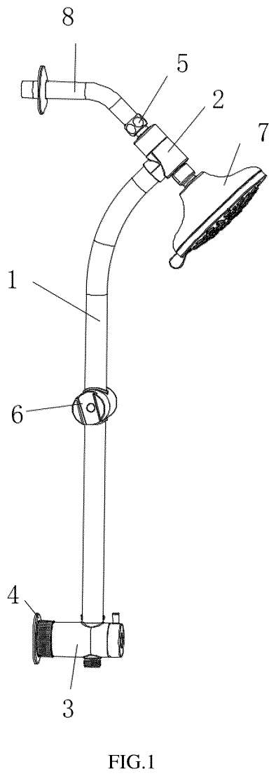

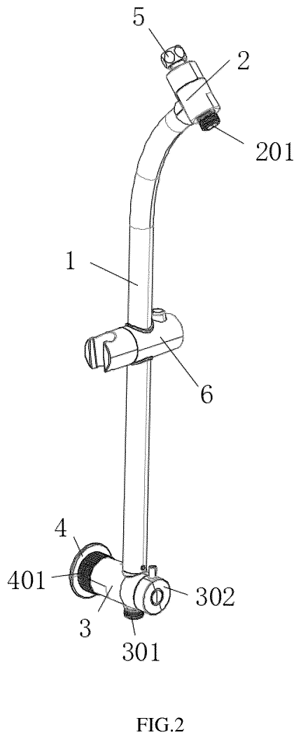

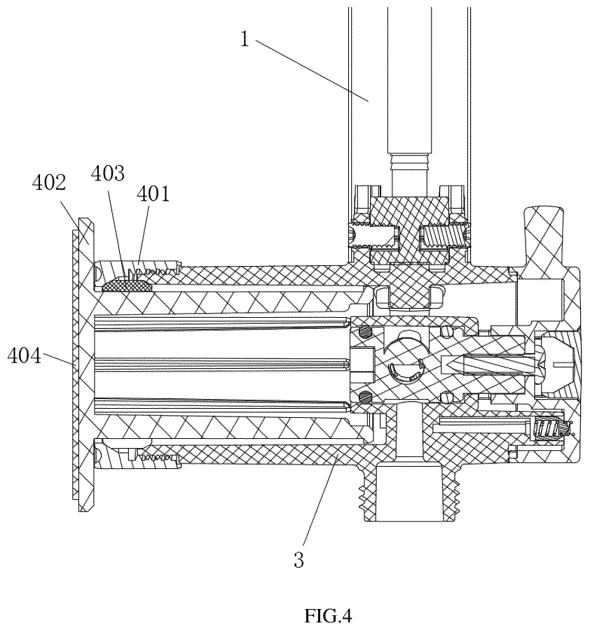

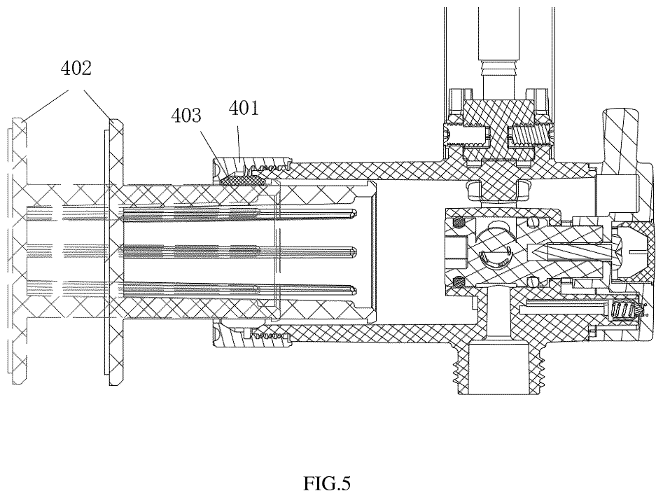

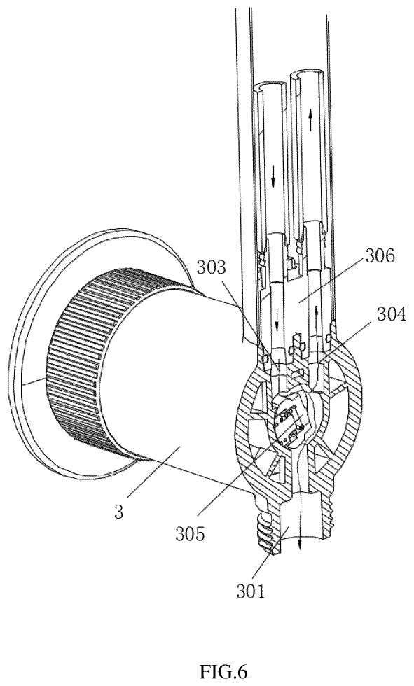

As shown in FIGS. 1-6, a shower column includes:
a lifting rod 1;
a first connection seat 2 arranged at an upper end of the lifting rod 1, wherein the first connection seat 2 is internally provided with two independent water passages; one of the two water passages is configured for water inlet and the other water passage is configured for water outlet, and the two water passages are mutually independent and are not connected to each other in the first connection seat 2;
a switching valve 3 arranged at a lower end of the lifting rod 1, wherein the switching valve 3 includes a valve water inlet 303, a first valve outlet 301, a second valve outlet 304, a valve core 305 and a switching handle 302.

The valve water inlet 303 and the second valve outlet 304 are respectively matched with an end of the two water passages. The valve water inlet 303, the first valve outlet 301 and the second valve outlet 304 are connected to each other. The switching handle 302 and the valve core 305 work together to change the connection relationship among the valve water inlet 303, the first valve outlet 301 and the second valve outlet 304. The valve core 305 can be rotated by rotating the switching handle 302, so as to control the valve core 305 to block the valve water inlet 303 or the first valve outlet 301 or the second valve outlet 304 or to not block them all, thereby changing the connection relationship among the valve water inlet 303, the first valve outlet 301 and the second valve outlet 304. Preferably, a second connection seat 306 is arranged at the valve water inlet 303 and the second valve outlet 304 of the switching valve 3, and the second connection seat 306 is also internally provided with two independent water passages. The two water passages each has an end and the ends of the two water passages respectively matched with the valve water inlet 303 and the second valve outlet 304.

The two water passages provided inside the first connection seat 2 each has an end and the ends of the two water passages are respectively connected to a top spray 7 and a water inlet elbow 8, and the water inlet elbow 8 is rotatably connected to the joint with the water passage. With the configuration that the water inlet elbow 8 is rotatably connected to the water passage at the joint position, the position and posture of the lifting rod 1 can be flexibly adjusted by rotation in practice.

A telescopic assembly 4 is arranged on a side of the switching valve 3, and the telescopic assembly 4 is configured to adjust the distance between the switching valve 3 and the wall body. The configuration of the telescopic assembly 4 allows the user to flexibly adjust the distance between the switching valve 3 and the wall body, thereby adjusting the distance between the lifting rod 1 and the wall body.

A shower assembly is connected to the first valve outlet 301. The shower assembly includes a hose and a hand-held shower, an end of the hose is connected to the first valve outlet 301, and another end of the hose is connected to the hand-held shower. The shower assembly is not shown in the drawings, and a conventional shower assembly may be used.

A lifter 6 is arranged on the lifting rod 1, and the lifter 6 is configured to place a hand-held shower. The cooperation between the lifter 6 and the lifting rod 1 is conventional prior art, and the specific structure is not repeated herein. The hand-held shower is held in the lifter 6, a user can flexibly adjust the height and angle of the lifter 6 on the lifting rod 1, and the angle between the hand-held shower and the lifter 1 may also be adjusted.

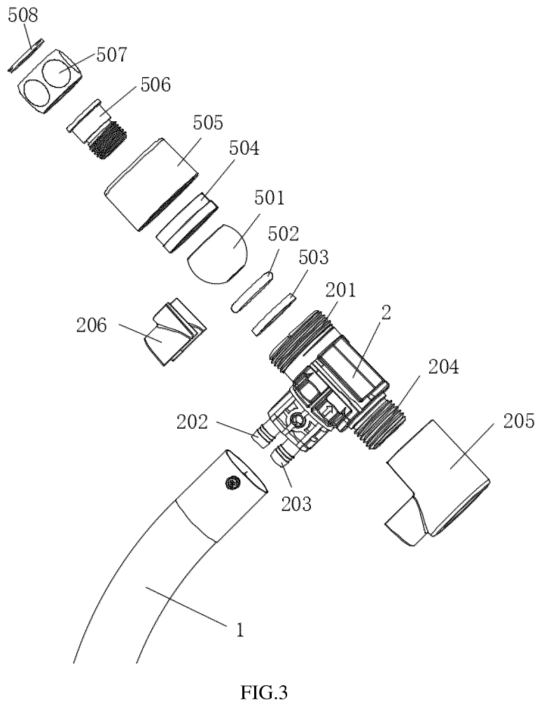

As shown in FIG. 3, the first connection seat 2 is provided with a first water inlet 201, a first water outlet 202, a second water inlet 203 and a second water outlet 204, the first water inlet 201 communicates with the first water outlet 202, and the second water inlet 203 communicates with the second water outlet 204.

As shown in FIG. 3, preferably, the position where the first connection seat 2 matches with the lifting rod 1 is provided with an end cover 205 and an outer shell 206 for protecting the first connection seat 2.

The valve water inlet 303 communicates with the first water outlet 202, and the second valve outlet 304 communicates with the second water inlet 203. Preferably, the water inlet 303 is connected to the first water outlet 202 by a hose, and the second valve outlet 304 is also connected to the second water inlet 203 by a hose, and the hoses may be arranged in the inner cavity of the lifting rod 1. Preferably, the valve water inlet 303 and the second valve outlet 304 are matched with the second connection seat 306, and then matched with the first water outlet 202 and the second water inlet 203 through a hose/hoses, and the hose/hoses is/are directly connected to the second connection seat 306.

The first water inlet 201 is connected to an end of the water inlet elbow 8 and is rotatably connected thereto, and the second water outlet 204 is connected to the top spray 7.

As shown in FIGS. 3-5, the telescopic assembly 4 includes a rotatable ring 401, a telescopic tube 402 and a clamping ring 403. The telescopic tube 402 is inserted into an inner cavity of the switching valve 3, and an end of the switching valve 3 that matches with the telescopic tube 402 is connected with the rotatable ring 401 by threads. The inner cavity of the rotatable ring 401 is provided with the clamping ring 403 for cooperation. The clamping ring 403 is sleeved on the circular outer wall of the telescopic tube 402. Chamfers are provided on two ends of the clamping ring 403. The inner wall of the rotatable ring 401 is provided with an inclined surface that matches with the chamfers. The rotatable ring 401 works with the clamping ring 403 to clamp or release the telescopic tube 402.

When the rotatable ring 401 is fastened by screwing, the inclined surface on the rotatable ring 401 and the chamfers on the clamping ring 403 have relative movement, thereby reducing the inner diameter of the clamping ring 403 and tightly clamping the telescopic tube 402. At this time, the telescopic tube 402 is unable to move on the switching valve 3. When the rotatable ring 401 is loosened by screwing, the inner diameter of the clamping ring 403 becomes larger, thereby releasing the telescopic tube 402, such that a user can flexibly move the telescopic tube 402 to change the length of the telescopic tube 402 inserted into the inner cavity of the switching valve 3.

Preferably, a side of the telescopic tube 402 that matches with the wall body is provided with an auxiliary washer to prevent wear of the telescopic tube 402. Preferably, the auxiliary washer may also be a vacuum suction cup or a magnetic sheet, so as to auxiliary fixing the telescopic tube 402.

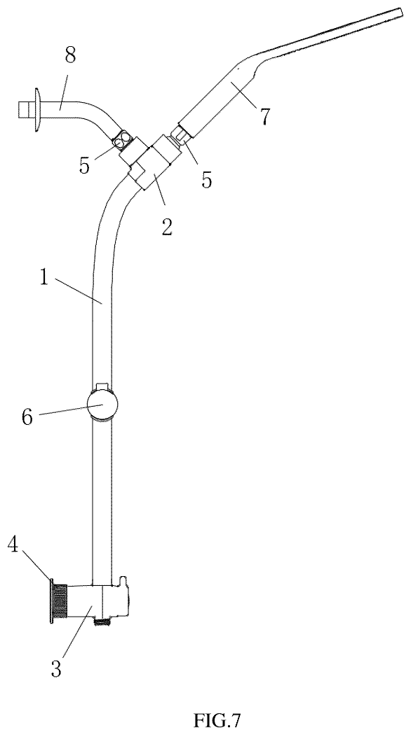

As shown in FIGS. 7-9, the water inlet elbow 8 is connected to the first water inlet 201 through the first rotary head 5 or the second rotary head 9.

As shown in FIG. 3, in a specific embodiment, the first rotary head 5 includes a ball head 501, the ball head 501 is arranged in the inner cavity of the first water inlet 201, a sealing ring 502 and a washer 503 are arranged between the ball head 501 and the first water inlet 201, and the sealing ring 502 contacts the ball head 501.

An end of the ball head 501 away from the first water inlet 201 is sleeved with a ball sleeve 504, and a compression nut 505 is connected to the first water inlet 201 by threads, and the compression nut 505 is configured to tightly compress the ball sleeve 504 and the ball head 501.

An end of the ball head 501 away from the first water inlet 201 is connected with a connector 506 by threads, and the connector 506 extends out of the compression nut 505. A connection nut 507 is sleeved on the connector 506, and a filter washer 508 is arranged inside the connection nut 507. The connection nut 507 is connected to an end of the water inlet elbow 8 by threads.

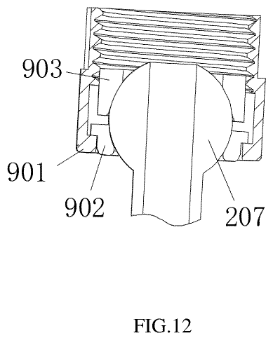

As shown in FIG. 12, in a specific embodiment, the second rotary head 9 includes a water inlet ball head 207 arranged at the first water inlet 201, the water inlet ball head 207 is provided with a connection sleeve 901, and the connection sleeve 901 is internally provided with a first spherical pad 902 and a second spherical pad 903. The first spherical pad 902 and the second spherical pad 903 are respectively mounted on an upper end and a lower end of the water inlet ball head 207.

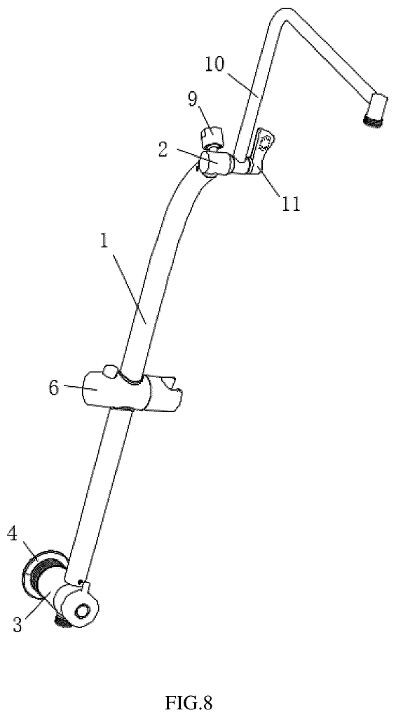

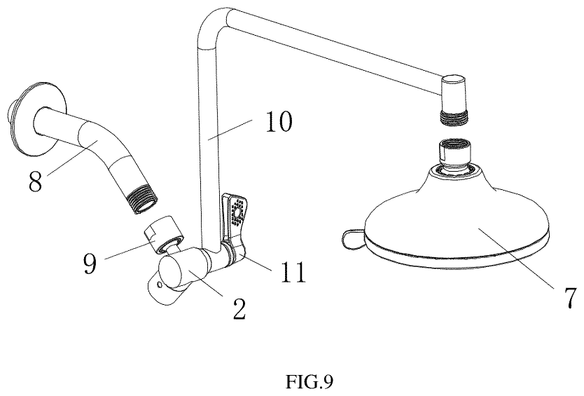

As shown in FIGS. 8-9, in a specific embodiment, the second water outlet 204 is connected to the top spray 7 through a cantilevered tube 10, the cantilevered tube 10 is rotatably connected to the second water outlet 204, and a locking assembly 11 is provided at the second water outlet 204 for locking the cantilevered tube 10 and the second water outlet 204. The arrangement of the cantilevered tube 10 allows a user to change the position of the top spray 7, thereby further improving the adaptability of the shower column.

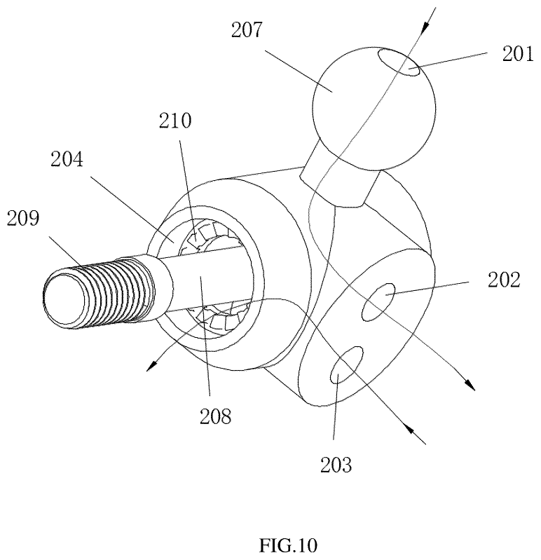

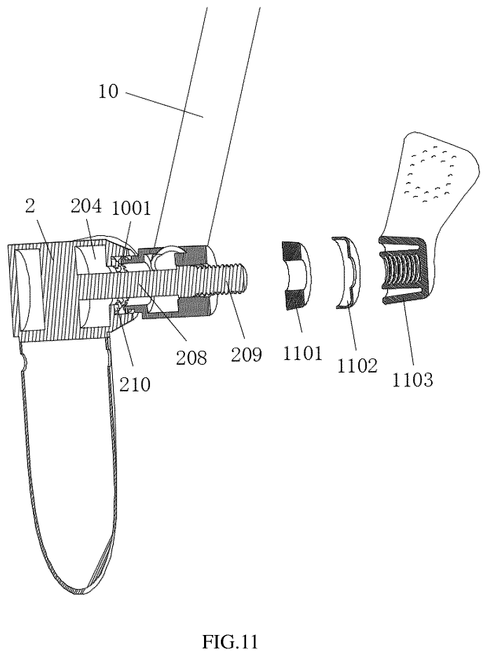

As shown in FIGS. 10-11, the locking assembly 11 includes a connection rod 208, an end of the connection rod 208 is connected to an inner cavity of the second water outlet 204, another end of the connection rod 208 extends to an outer side of the second water outlet 204, and is connected to a threaded rod 209. The connection rod 208 and the threaded rod 209 are arranged in coaxial with the second water outlet 204, an end of the cantilevered tube 10 is sleeved on the connection rod 208, the threaded rod 209 passes through the cantilevered tube 10. A wear-resistant ring 1101 and a decorative cover 1102 are sequentially sleeved on the threaded rod 209, and then the threaded rod 209 is connected to an adjustment handle 1103 by threads.

As shown in FIG. 11, the inner cavity of the second water outlet 204 is provided with a first toothed disk 210 that matches with the cantilevered tube 10, and a second toothed disk 1001 is provided on a surface where the cantilevered tube 10 matches with the second water outlet 204, and the first toothed disk 210 is adapted to the second toothed disk 1001.

As shown in FIG. 11, after tightening the adjustment handle 1103, the adjustment handle 1103 tightly compresses the decorative cover 1102, the wear-resistant ring 1101 and an end of the cantilevered tube 10 on the first connection seat 2 in sequence. The second toothed disk 1001 on the cantilevered tube 10 is engaged with the first toothed disk 210 on the first connection seat 2, and the cantilevered tube 10 cannot rotate and is fixedly connected to the first connection seat 2.

When the adjustment handle 1103 is released, the second toothed disk 1001 on the cantilevered tube 10 is rotatable relative to the first toothed disk 210 on the first connection seat 2, and an operator can adjust the angle of the cantilevered tube 10, thereby adjusting the angle of the top spray 7.

As shown in FIG. 7, in a specific embodiment, the top spray 7 is rotatably connected to the first connection seat 2 via the first rotary head 5, so that the operator can also conveniently adjust the posture of the top spay 7 in use.

Preferably, the cantilevered tube 10 and the top spray 7 may also be connected through the first rotary head 5 or the second rotary head 9, so as to further improve the rotational freedom of the top spray 7, so that the operator can adjust the top spray 7 to a satisfactory posture in use.

The above description merely involves preferred embodiment of the present disclosure. It should be noted that a person skilled in the art can make several modifications and improvements without departing from the inventive concept of the present disclosure, and these modifications and improvements should be considered as falling within the protection scope of the present disclosure.

What is claimed is:

1. A shower column, comprising:
a lifting rod;
a first connection seat, wherein the first connection seat is arranged on an upper end of the lifting rod, and the first connection seat is internally provided with two independent water passages;
a switching valve, wherein the switching valve is arranged on a lower end of the lifting rod, the switching valve comprises a valve water inlet, a first valve outlet and a second valve outlet, and the valve water inlet, the first valve outlet and the second valve outlet are in communication with each other, the switching valve is provided with a switching assembly configured to switch a connection relationship among the valve water inlet, the first valve outlet and the second valve outlet;
the two water passages provided in an interior of the first connection seat each has a first end and the first ends of the water passages are respectively connected to a top spray and a water inlet elbow, the water inlet elbow is rotatably connected to the water passage at a joint position, the two water passages each has a second end and the second ends of the water passages are respectively connected to the valve water inlet and the second valve outlet;
a telescopic assembly, wherein the telescopic assembly is arranged on a side of the switching valve, and the telescopic assembly is configured to adjust a distance between the switching valve and a wall body; and
a shower assembly, wherein the shower assembly communicates with the first valve outlet.

2. The shower column according to claim 1, wherein
the first connection seat is provided with a first water inlet, a first water outlet, a second water inlet and a second water outlet, the first water inlet communicates with the first water outlet, and the second water inlet communicates with the second water outlet, thereby forming the two water passages;
the water inlet communicates with the first water outlet, and the second valve outlet communicates with the second water inlet, the first water inlet communicates with an end of the water inlet elbow and is rotatably connected thereto, and the second water outlet communicates with the top spray; and
the switching assembly comprises a valve core and a switching handle, and the switching handle works with the valve core to change the connection relationship among the valve water inlet, the first valve outlet and the second valve outlet.

3. The shower column according to claim 1, wherein
the telescopic assembly comprises a rotatable ring, a telescopic tube and a clamping ring, the telescopic tube is inserted into an inner cavity of the switching valve, the switching valve is connected to the rotatable ring by threads at an end of the switching valve matching with the telescopic tube, an inner cavity of the rotatable ring is configured with the clamping ring for cooperation, the clamping ring is sleeved on a circular outer wall of the telescopic tube, chamfers are provided at two ends of the clamping ring, an inclined surface that fits with the chamfers is provided on an inner wall of the rotatable ring, and the rotatable ring and the clamping ring work together to clamp or release the telescopic tube.

4. The shower column according to claim 2, wherein
the water inlet elbow communicates with the first water inlet through a first rotary head or a second rotary head.

5. The shower column according to claim 4, wherein
the first rotary head comprises a ball head, the ball head is arranged in an inner cavity of the first water inlet, a sealing ring and a washer are arranged between the ball head and the first water inlet, and the sealing ring contacts the ball head;
an end of the ball head away from the first water inlet is sleeved with a ball sleeve, the first water inlet is connected with a compression nut by threads, and the compression nut is configured to compress the ball sleeve and the ball head; and
an end of the ball head away from the first water inlet is connected with a connector by threads, the connector extends out of the compression nut, a connection nut is sleeved on the connector, an interior of the connection nut is provided with a filter washer, and the connection nut is connected to an end of the water inlet elbow by threads.

6. The shower column according to claim 4, wherein
the second rotary head comprises a water inlet ball head arranged at the first water inlet, a connection sleeve is sleeved on the water inlet ball head, an interior of the connection sleeve is provided with a first spherical pad and a second spherical pad, and the first spherical pad and the second spherical pad are respectively mounted on an upper end and a lower end of the water inlet ball head.

7. The shower column according to claim 2, wherein
the second water outlet is connected to the top spray via a cantilevered tube, the cantilevered tube is rotatably connected to the second water outlet, and a locking assembly is provided at the second water outlet for locking the cantilevered tube and the second water outlet.

8. The shower column according to claim 7, wherein
the locking assembly comprises a connection rod, a first end of the connection rod is connected to an inner cavity of the second water outlet, a second end of the connection rod extends to an outer side of the second water outlet and is connected to a threaded rod, the connection rod and the threaded rod are arranged in coaxial with the second water outlet, an end of the cantilevered tube is sleeved on the connection rod, the threaded rod passes through the cantilevered tube, and the threaded rod is sequentially sleeved with a wear-resistant ring and a decorative cover and then connected to an adjustment handle by threads.

9. The shower column according to claim 8, wherein
an inner cavity of the second water outlet is provided with a first toothed disk matched with the cantilevered tube, and a surface where the cantilevered tube matches with the second water outlet is provided with a second toothed disk, and the first toothed disk is adapted to the second toothed disk.

10. The shower column according to claim 1, wherein
the shower assembly comprises a hose and a handheld shower, a first end of the hose is connected to the first valve outlet, and a second end of the hose is connected to the handheld shower, the lifting rod is provided with a lifter, and the lifter is configured to place the handheld shower.
